(19) United States
(12) Patent Application Publication
(10) Pub. No.: US 2010/0154007 A1
(43) Pub. Date: Jun. 17, 2010

(54) EMBEDDED VIDEO ADVERTISING METHOD AND SYSTEM

(76) Inventors: Jean Touboul, Boynton Beach, FL (US); James Popoff, West Palm Beach, FL (US)

Correspondence Address: PRYOR CASHMAN, LLP, 7 Times Square, NEW YORK, NY, 10036-6569, US

(21) Appl. No.: 12/427,269

(22) Filed: Apr. 21, 2009

Related U.S. Application Data
(60) Provisional application No. 61/138,215, filed on Dec. 17, 2008.

(51) Int. Cl. H04N 5/445; G06F 17/30

(52) U.S. Cl. 725/60; 725/113; 725/115; 707/E17.005; 707/E17.014

(57) ABSTRACT

A method of associating primary content in a broadcast video program with secondary content information not shown in the program is provided. A broadcastable video program of primary content is provided on a machine-readable medium, the program having successive image frames and each frame having a plurality of coordinates. Codes are embedded in at least some of the frames, each code corresponding to an area of coordinates of the image frames. Each code is linked via links to information of secondary content not appearing in the image frames of the program, at least one of the links or the linked-to information being stored on a computer-readable medium. An interactable interface is provided to program viewers of the primary content adapted to allow the viewers to activate the embedded links and retrieve the secondary content of the linked-to information. Different viewers may receive different secondary content based on demographic variables.

### RELATED APPLICATIONS

Domestic priority is claimed from U.S. Provisional Patent Application No. 61/138,215, filed Dec. 17, 2008, entitled “EnContext Advertising”, the entirety of which is incorporated by reference herein.

### BACKGROUND OF THE INVENTION

1. Field of the Invention

The invention is directed to systems and methods of broadcasting video programming, and is more particularly directed to systems and methods of associating secondary content such as advertising with the primary content of a video program.

2. Description of Related Art

There are several existing methods of shopping using television broadcasts or the internet. None has the immediacy or effectiveness of the invention.

A (Broadcast, Cable, or internet) TV Commercial is alternative content to a main program that is serially multiplexed in the main program. The content is syndicated (national ads already in the main program frames sent by the distribution node) or free space allocated to the distributor and filled with content such as distributor-level syndicated content or local ads. Viewers can form impressions and see information such as addresses, URLs and telephone numbers.

A TV Crawler is additional information to the main program multiplexed with the program frames so that text appears to move across the bottom of the screen. The content may be synchronized and complementary with the main program content, or it may be unrelated. The viewer forms impressions and retrieves information such as URLs and telephone numbers.

Interactive TV presently takes two main forms: in the first, viewers respond to stimuli or questions posed by participants in the main program, using current pointing technologies such as a “second screen solution” utilizing a separate computer and internet connection, or via infrared-based enhanced remote-control units that communicate with the screen or with a settop box sending signals over a cable connection. The responses are collected and viewers are not individually identified or corresponded with. An example is a program where viewers vote on alternative plot lines. In the second form, individual viewers are identified and correspond with the program content. An example is a program selling directly to the public. Internet/cable connections or telephone are used by viewers to respond and communicate with program content. A simpler variation is the telethon-style program, where viewers are encouraged to call in by telephone with pledges or with their purchase information.

Internet Banner Ads consist of graphics and text inserted using HTML/XHTML code into any area of the web page. An active pixel in the area can link the viewer with another web page, and the ad also forms impressions and provides information (addresses, URLs, phone numbers).

Internet Pop-Up Ads are similar to the Banner Ads above in the sense that they are also created by XHTML/HTML code and occupy an area on the web page, but they use dynamic principles to operate (dynamically “popping” up, possibly using animation/video to communicate, etc.) instead of sitting there waiting to be “clicked” by the viewer (although they also contain a “pixel”). Viewers are theoretically more “engaged” by the popup, as well as animation/video, than by merely forming impressions, and information such as addresses, URLs, and telephone numbers is also provided.

Internet E-Mail Offers are unsolicited (“spam”) or by invitation and encourage the reader to click on a supplied URL. If they click, they are redirected to a web page that may contain banners, pop-ups or multimedia presentations and pixels, impressions, and information as above.

### SUMMARY OF THE INVENTION

The present invention relates to a new method that enables viewers of Television and video and multimedia programs to access advertising while watching a TV broadcast, movie, or video via cable television, video playback device or the Internet. The inventive system enables viewers to point and click at any item on a TV or computer screen where images from a scene of a program are being displayed, and be instantly connected to an Offer that consists of a link to a website providing a way to purchase this item or access information on the item selected.

The invention's unique approach is to “embed” advertising opportunities within the frames of a program. Each opportunity corresponds to a specific item within an image and is identified via a Tag that is identified with a unique ID# and contains specific information concerning this item. This information consists of various elements including the name given to this item, keywords that identified it, categories where it may belong and other parameters to better identify this item and the context in which it is presented. Finally these Tags provide for the “mechanism” to link these items and viewer's selection to offers that consist of links to a website containing the option to purchase the item selected or information associated to this item. In some instances these Offers may consist of a simple banner or message that is displayed over the image.

To allow these offers to be displayed on the screen, the Tag sends a query to a data base of information that is remotely positioned and that is accessed via an Internet connection (when a program is pre-recorded on a media such as a DVD these offers may be contained on one of the program's tracks). The function of the Tag is then to contain the details of the query (including URL for data base or local track information) and send along the specific request to the data base in order to find the best possible offer. The data base will then search for offers corresponding to the criteria presented to it by the Tag content, find the best possible match(es), filter these results through any pre-established business rules (these may be in the form of simple optimization criteria based on viewer's profile, IP address or any other parameters available to refine results), and return the best offer.

One goal of the invention is to enable movie or TV (i.e., content) producers and any broadcast program owner to offer to sell or provide information on any product or item(s) featured in a video in a program. The invention further provides viewers better control over what advertised product, service, commercial or other thing they want to get information on and, if desired, to buy the same with minimum intrusion.

The invention is a method and system of associating primary content in a broadcast video program with secondary content information not shown in the program. A method of associating primary content in a broadcast video program with secondary content information not shown in the program is provided. A broadcast, cable and/or video program of primary content is provided on a machine-readable medium, the program having successive image frames and each frame having a plurality of monitor or viewable coordinates. Codes are embedded in at least some of the frames at the coordinates, each code corresponding to at least one coordinate or an area of coordinates of the image frames. Each code is linked via links to information of secondary content not initially visually appearing in the image frames of the program, at least one of the links or the linked-to information being stored on a computer-readable medium. An interactable interface is provided to program viewers of the primary content adapted to allow the viewers to activate the embedded links (by selecting the link at the coordinate(s)) and to thus retrieve the secondary content of the linked-to information.

Preferably, the coordinates include pixels in an X-Y array, and the area of coordinates substantially corresponds to the physical outline of an object shown in the image frames. Each coded object preferably has X-Y spatial frame coordinates and Z-frame info identifying the object in space (X-Y) and time (Z) in the program.

It is preferred that the video program primary content be provided on a first machine-readable medium (a computer monitor, television, video screen or monitor) and the linked-to information corresponding to the secondary content on a second machine-readable medium. More preferably, the broadcast video program primary content is provided on a broadcaster's server yet viewable by the user/consumer on a video screen, and the linked-to information secondary content be ultimately obtainable and provided on an advertiser's server. The linked-to secondary content information pertains to the primary content object tagged by the code and selected by the consumer/user. The viewer of the program is enabled to purchase an instance of the tagged object selected by the viewer and/or obtain information on the goods/services selected by the user/consumer.

Preferably, the selected linked-to secondary content is overlaid atop the primary content corresponding to either the embedded code or the coded object. Different links to different secondary content may be provided to different viewers based on viewer location or other demographic variables. Alternatively, different codes may be embedded corresponding to different areas of even a single image frame (and thus different objects) for different viewers based on viewer demographic variables are available.

The codes are preferably embedded in the following manner. First, the primary content video program is scanned. Objects (for ease of illustration we use objects and, yet, of course, the invention is related to services, too, as, for example, if an image is shown of a baseball game then the secondary content may be access to tickets to a baseball game) are shown in the image frames and detected, and codes corresponding to the detected objects are embedded. Any of the scanning, detecting, and embedding steps may be performed by a pattern recognition program or by a human operator.

### BRIEF DESCRIPTION OF THE DRAWINGS

FIG. 1 is a schematic diagram showing an overview of an embodiment of the invention.

FIG. 2 is a schematic diagram showing a more detailed view of the embodiment of FIG. 1.

FIG. 3 is a schematic diagram showing an embodiment of the invention utilizing a cable or television broadcast and a remote database.

FIG. 3A is a schematic diagram showing an embodiment of the invention utilizing a cable or television broadcast and an integrated database.

FIG. 4 is a schematic diagram showing an embodiment of the invention utilizing a video playback device having internet access.

FIG. 4A is a schematic diagram showing an embodiment of the invention utilizing a video playback device having no immediate internet access.

FIG. 4B is a schematic diagram showing an embodiment of the invention utilizing a self-contained video playback device not requiring an internet connection.

FIG. 5 is a logic flow chart depicting the serving of advertiser domains having an exclusive agreement with the broadcaster.

FIG. 5A is a logic flow chart depicting the serving of advertiser domains not having an exclusive agreement with the broadcaster and/or utilizing a bid selection process.

FIG. 6 is a schematic diagram showing the invention offering different linked secondary content information to different viewers of the primary content program based on viewer demographics such as, for example, geographical location.

FIG. 7 is a schematic diagram illustrating the encoding process of the invention.

FIG. 8 is a logic flow diagram depicting the inventive process and the sequence of steps when a viewer of the encoded video program interacts with the program.

FIG. 9 is a schematic diagram showing Ginga Middleware Architecture as an example of one existing technology that can be utilized to provide a working environment for the invention.

### DETAILED DESCRIPTION OF THE INVENTION AND DRAWINGS

The invention is unique since it delivers Offers for available goods and services in the form of a website link or a message at the exact moment when viewers are the most inclined to want something that one of their heroes is using, wearing, or doing, i.e., they can request information on the product or service at the time of viewing. Furthermore, these Offers may not be limited to specific items or objects on a screen but could also include themes within a scene such as the theme of a scene (for example a scene takes place on an Hawaiian island and information on the island or a travel offer may be tied to that theme).

However to avoid interfering with a viewer's enjoyment of a movie or program, the inventive system provides for the use of optional multiple settings to suit each viewer's personal needs. A viewer can change his personal settings to 1) select to see Offers at the moment opportunities are available within a scene, 2) see buying opportunities listed in a band rolling at the bottom of the screen (we call it caption style) as it is commonly used in newscasts today, or 3) select to view these opportunities at the end of the video program with an option to review each one within the context of the scene, shown in playback mode. In that last setting (3), a user can activate a buying opportunity (Ad) by simply pointing and clicking on any item within the selected and storing the scene, enabling the system to capture the action for later review or for immediate review.

This approach ensures that every viewer has the ability to tailor the invention to his or her viewing habits or desires when watching an encoded program or movie.

Finally, the system has a built-in smart technology that recognizes “live” programs versus recorded ones. As a result, to avoid interruption of the program during a “live” event, the invention will automatically record the action of a viewer pointing and clicking on items and will later show the list of these actions for the viewer to select from. However for pre-recorded programs, or during the viewing of a video when stopping the program is possible (freeze frame), the viewer will have the ability to view Ads and be linked to an advertiser's website or other source of information. When the viewer will later return to the program, he/she will be able to restart the program exactly where it was stopped.

And while buying opportunities and their corresponding Offers are one of the goals of the invention, this solution is a powerful option for complementing educational programs, documentaries, travel guides, etc. This could be accomplished via a simple linking of the Tag corresponding to a specific area of a scene or frame to an informational website such as Wikepedia.com, search engines like Google, or any appropriate website(s) e.g., Orbitz, Travelocity, Priceline, etc.

### Adaptability

The invention is adaptable to any format of broadcasting and video in any country.

Internet TV

Producers can release TV shows, Motion Pictures films and video programs with embedded buying opportunities with Offers linked to associated websites which provide the information, goods and/or services.

Cable Television and Video on Demand

Producers and distributors of any type of motion picture films and video programs are able to embed opportunities and could greatly benefit from revenues generated from clicks and actions taken by viewers. At the same time, the invention provides the option to enrich the viewer's experience via links to informational websites in addition to buying opportunities.

Traditional Television Broadcast

Broadcasters and show producers using the invention have the means to find alternative ways to advertise products and services and enhance the viewer's experience by providing any types of links. Of course this ensures success to the producers in that they can further maximize their return on their creative investment.

Distributed Video Programs

With the standardization of DVD-type players and high definition screens on PCs (as well as the “plug and Play” concept of media players and other mass storage devices), viewing pre-recorded videos on personal computers has become routine. As a consequence of the invention, producers and distributors will also have the ability to enhance viewers' experience while deriving new revenues from their products.

Deployed ROM

A “Forward Deployed” embodiment of the invention is another approach that is being developed for the situation where the viewer is not able to connect to the Internet while watching the program, such as when the service is down for technical reasons, or when in an isolated setting. An obvious example would arise while travelling by automobile across an isolated area with children in the back seats who are watching a DVD and wishing to connect to additional information about something in the program that interests them. In such a situation, tagging and encoding in accordance with the invention would be available as usual within the video signal to the display screen, and would be included in the playback hardware similar to a solid-state hard drive or insertable memory card. Similar technology would allow a viewer in a public movie theater to view along with others and yet their seat could be provided with a pointer which would record that seat's selected goods and services for recording onto a memory card for later viewing when connected to the internet. That unit could display the Tags at the time they are requested, or else it could “store and forward” the clicks when the unit is within range of an Internet connection once again. The unit could also be designed to plug into laptop or notebook computers, etc. when they are being used as portable playback devices but lack an Internet connection at the time.

### Global Reach

Because the invention is a stand alone system that is embedded in the video signal, international television standards such PAL, SECAM, NTSC, etc. are not an impediment to the implementation of this system

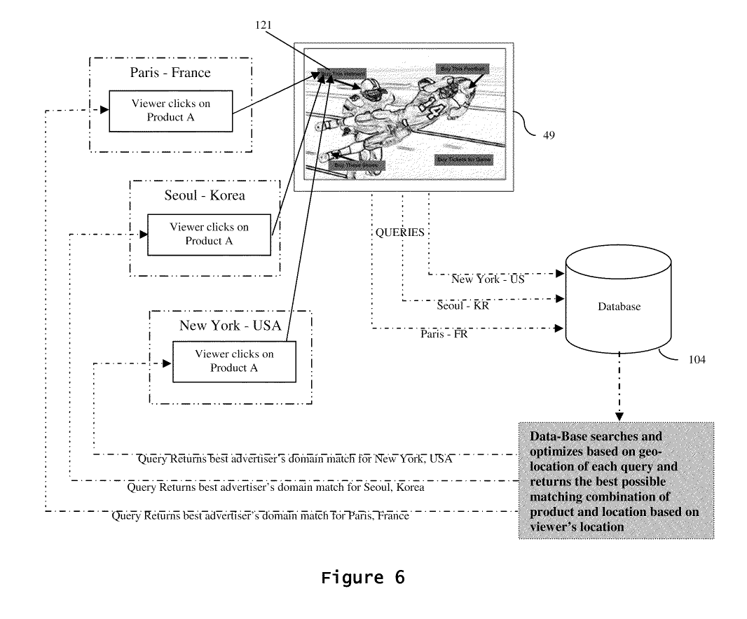

Another goal of the invention is also to be a global solution offering adaptability to any television format, and enabling the simulcast (or delayed broadcast) of a single program in any country with geo-targeted Offers. This will be possible as a consequence of the system's ability to “recognize” the origin of a query (when a viewer clicks on an item) and, when available, to deliver a place of purchase (a local website URL) based on the location of the viewer as shown below (see FIG. 6 and explanation for more details).

The invention is based on a very sophisticated system of tagging of products and goods and other items that visually appear on a screen or are suggested thereby. These Tags include specific descriptions of products and items as well as keywords. This information is in turn used to find advertisers' websites and/or informational domains on a database (local or remote). When a match is found, the database returns the website address and loads the page on the internet browser made available to the viewer (then or later).

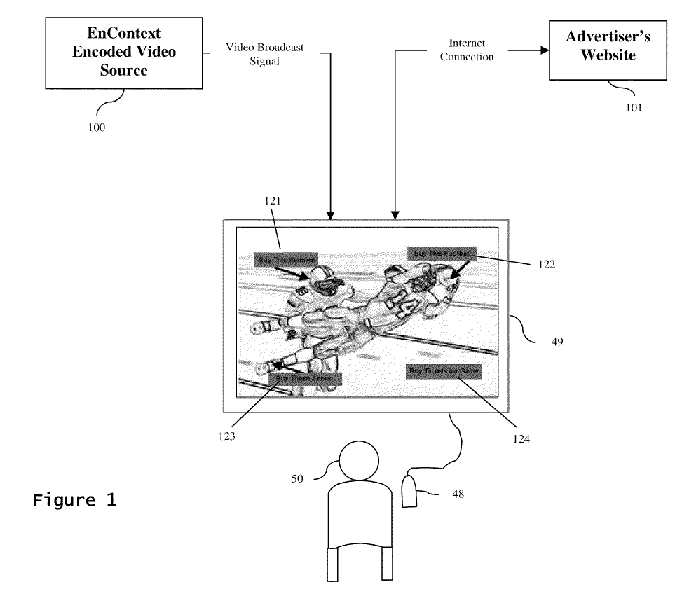

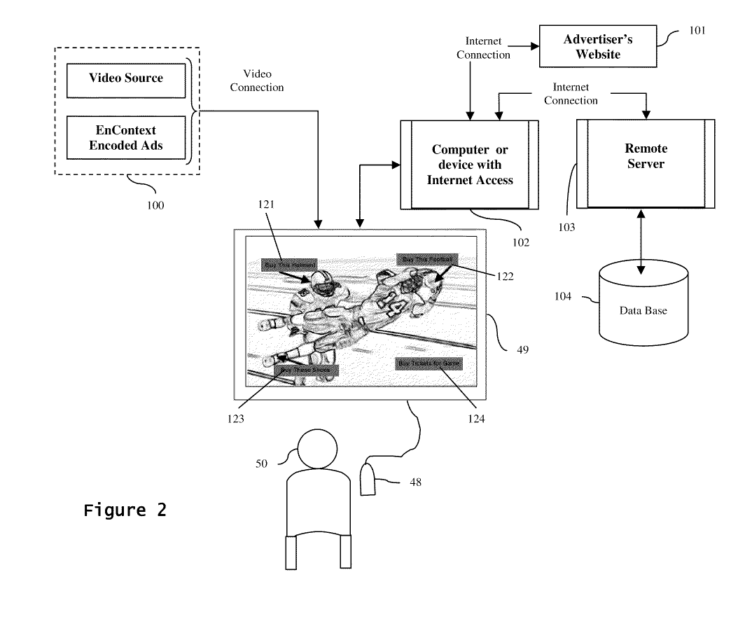

In the example shown in FIGS. 1 and 2, the Tags allow the viewer to select a number of items that can be purchased or for which information can be provided.

In these examples (FIGS. 1 and 2) two football players of the Denver Broncos and Oakland Raiders (for the sake of example) are featured fighting for a ball. This action may apply for a pre-recorded program or motion picture film and, potentially for a live game. In this example several options are available for matching Tags and advertisers and they include:

1) The “Buy This Helmet” Tag is embedded in this scene and includes a series of keywords like “football helmet”, “Denver Broncos”, “NFL”, “AFC”, “football”, as well as any description to illustrate the situation including names of players or characters, name of field, game, championship, etc.

2) The “Buy This Football” Tag is embedded in this scene and includes keywords like “football”, “Wilson” (for our example we assume that the ball is made by this company), “NFL”, “ball”, etc. Here again comments similar to 1) would be added as well.

3) The same applies for “Buy These Shoes” with keywords like “football shoes”, “Nike”, “NFL”, “football”, and again for “Buy Games Tickets” including the keywords “football tickets”, “NFL”, “football”. Here again comments would be added or simply copied from Tag to Tag.

Once the embedding is completed (by the producer or an after-market supplier), the system is then ready to be distributed and run and when commanded to query by a consumer/viewer a database (these records can also be contained on the DVD or any other playing device from which the program is played back), it searches for and selects a match allowing the user to link to the advertiser's website.

### The Payout Models

As a result, for the example discussed above, broadcast owners and producers of content have a number of options available for structuring a number of commercial agreements with advertisers. For example an agreement with the Denver Broncos' online store with links to the pages offering Broncos' collectible helmets is an option for the provider/distributor/content provider of an NFL game or video product. Relatedly, an agreement with Wilson Sporting Goods might connect game or video viewers to the page featuring the latest Super Bowl commemorative football from Wilson. The same is possible for Nike, enabling the viewer of the NFL product (game or video) to click and connect to Nike's online store on the page featuring Nike's latest football shoes. And, again, viewers may have the option to link with Ticketmaster, either at the time of viewing or later, after the game/viewing.

This example can be enlarged upon with an information-providing link to the NFL giving viewers the option to link to the web pages of the NFL and learn about football or any related topic of interest for viewers.

Another aspect of the invention is that when links are served dynamically the system can be “fine tuned” to select and provide access to or “serve” the best matching link that corresponds to the embedded Tags, but also to support the program provider or owner's own commercial objectives, or else reflect the availability of advertisers for a given type of product and/or service.

For example a re-direct of any of these links to the Broncos' website, for example, may be further re-directed to an online sporting goods store selling these items should the program owner decide to “auction” the link to the store providing the best (as determined by the content provider) combination of availability of product, price to consumer, and/or service charge based on clicks of interest or actual completed sales to the content provider (or any combination of these and other factors to be commercially considered).

In other words, the invention gives broadcast providers/owners the option to select the destination of the link based on their criteria, the agreements they have in place, exclusivity or a non-exclusive deal, etc. Below are two examples of the type of deal that a program owner may put in place and how the system could work.

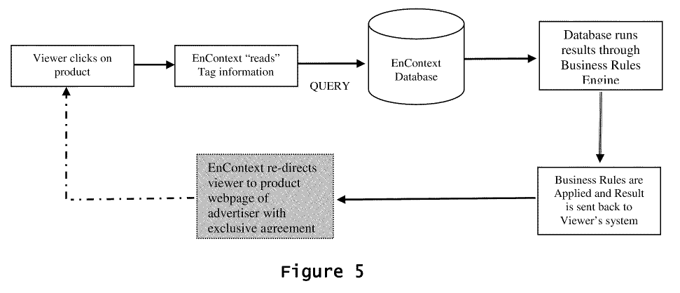

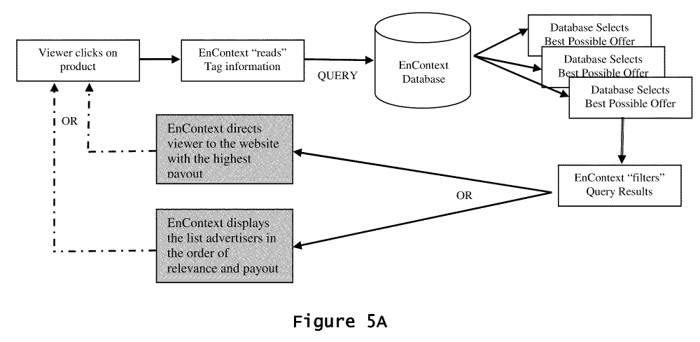

Two distinctive Payout models are possible, and they include:
1) Payout model based on an Exclusivity Agreement as shown in FIG. 5 whereby the data base, responding to a query from an Ad on a program, will return a pre-defined offer/information and/or link to any one advertiser's website.
2) Payout model based on a Non-Exclusive or Bid Agreement as shown in FIG. 5A whereby the data base, responding to a query from an Ad on a program, will find one or more possible offers matching the Ad and return one or more offers/information modules or links to “best” matching advertisers.

In both instances, the decision will be made via a program that will contain Business Rules (the Business Engine) and that runs along with the data base. The Business Engines will be programmable to establish the rule(s) for each Ad and define how and what to select from the data base and which results to provide to the consumer before this information is communicated back to the viewer.

Business rules will include the type of Offer to serve (exclusive, non exclusive, bid types, etc.) as well as geo location, demographics, trends, and all other parameters used in order to better target offers.

Additionally the system enables broadcast owners and producers to use various types of payouts enhancing their ability to put in place lucrative agreements (regardless of exclusivity or non-exclusivity deals). Some examples of payouts are:

Pay Per View—modeled after the traditional broadcast advertising model

Pay per Click—modeled after the search engines type of ad placement commonly used in the online industry

Pay Per Action—modeled on a “profit” sharing agreement and consisting of an action-defined payout such as “pay per lead”, “pay per purchase”, “pay per enrollment”, “pay per completion” (for sweepstakes or survey), etc.

In all instances the central database will be able to preserve all records of programs, Tags and encoding, as well as links to advertisers' websites and information sites. This, however, does not preclude a licensed or privately owned system that could be operated independently. In this instance the central database would re-direct the query to the independently-operated system. This in turn, enables the system to offer very flexible business models and Rules/Engines, each fitting the client's (content provider's) proprietary objectives and goals.

To manage and deliver the system, a software suite is employed which is referred to as the “EnContext Controller Application” or ECA. ECA comprises four distinctive components:

1) The selection and tagging (referred in this document as “Tags”) of products (and/or services) and items physically shown or suggested by language, action, etc. on a video-based program (motion picture film, TV (broadcast, cable, satellite, etc.) or video that offer purchase and informational opportunities to a viewer.

2) The encoding of this program (either before release to the viewer or simultaneously with dissemination) with these purchase opportunities in relation to the spatial location of the product or item selected.

3) The classification and merging of the information contained by these Tags' with advertising or informational messages embedded in the program or delivered via a database of ads (often referred to in this document as “Offers”)

4) Finally, the optimization of these Offers to deliver a best possible match based on user profile, geo-location as well as any other business criteria and/or filters.

### 1) Tagging Methodologies

### 1) EnContext Tagging and Encoding Process (ETEP)

Two methods are possible for this technique, a semi-automatic process (method 1) for tagging and encoding video programs, and a fully automated process (method 2) for tagging and encoding video programs.

### ETEP Method 1—Semi Automatic Tagging and Encoding Process

This process includes the review and manual tagging of all products, goods, merchandise, services and businesses that appear or are suggested by the actors, the language, the physical objects shown in the scenes of a film, TV or video program.

The initial embedding of the Tags, in this version of the process involves individuals/operators reviewing the scenes of a video, motion picture film or broadcast and identifying items of potential interest to the viewers, such as products, services, merchandise or businesses in each scene. Examples of these could be cars (type and brand), clothing (pants, suits, dresses, coats, etc.), accessories (watches, jewelry, decorations, etc.), businesses (McDonalds, Starbucks, etc.), travel plans (such as a beach in Hawaii or a famous art museum), etc.

Operators preview the video program and, using the ECA manually “Tag” by a computer listing each product using keywords such as car, convertible, Ford, Mustang, Hawaii, The Louvre, Pants Suit, Calvin Klein, etc., and additional descriptions (for example, name of actor who is driving the car, name of his character, etc.) in the example of a car driving across a scene. Simultaneously, the system encodes the video program by recording the physical coordinates of these products in the overall picture (e.g., pixel by pixel cross-references) and associates this information with the “Tags” that were created for each product or service and that is then included as potential keywords and additional information for each shown scene. The precise boundary of the object in question may be traced. Alternatively, and more preferably, an approximation of the perimeter of the object can be utilized, because the tracing of an object frame by frame may be extremely labor intensive (whether performed manually or by pattern recognition software). For example, the object approximation may take the form of a rectangle, circle, oval, or similar polygon that substantially encompasses the object in question. In any event, the Tag format will be standardized for each payout scenario as depicted below, but may include more or less additional item details, background information, or links to URLs. The management of this part of the system is not the responsibility of the Operators of the ECA, who merely identify and track objects from the list that have been supplied to them, and provide the objects with names according to the indicated format.

At the end of this process the video, motion picture film or televised program (independent of manner of distribution) will contain Tags corresponding to many if not all advertising opportunities identified, as well as their exact location within the program by scene, time from beginning of video, location on the scene, etc. These in turn will be ready to be “married” with Ads, in context with any or all of the products, goods, or business opportunities available as explained below.

### Description of Operator's ECA

DB's index on video ‘z’ (time) dimension with each ‘z’ identifying a separate frame page's data;
   (1) Interactive Graphical User Interface (GUI) splits Operator's screen into multiple parts, including:
      A database browser and editor application that is able to construct
      temporary working files for building the Tags and associating keywords
      and/or additional Information, and links to a storage location for the permanent Tag file;
      A window showing what the viewer's screen displays, with the scene that is being tagged.
   (2) Operator identifies a block of ‘z’ (time origination and/or duration values for each object's duration on screen (an object may reappear in multiple scenes, but during each scene that duration in which the object is visible constitutes a separate scene-event for that object).
   (3) Operator selects object's physical region to be described in Cartesian coordinates using (x-min, y-min), (x-min, y-max), (x-max, y-max), and (x-max, y-min) to construct a “minimum bounding rectangle” (a technical term from remote-sensing/photo interpretation/GIS) using any commonly-available cursor application adapted for this purpose;
      Operator scans the block of z-values and identifies each ‘z’ frame where the object is at an extreme (i.e., the top, bottom, left margin, right margin of the object's motion or progress across the scene).
         For example, imagine a character wandering back and forth across a room in a distraught state after learning some momentous news; the items of apparel or accessories that the character is wearing/using will also transit the scene and the Operator will note the ‘z’ frames where extremes in their location occur.
   (4) Operator provides a name, called an EnContext Tag, then stores the
      Tag, any additional names or keywords, additional information, etc. together with the block of ‘z’ values during which the object appears in the scene, and the Object envelope coordinates at each of the extreme locations, together with the ‘z’ frames in which the extreme locations occur, in the permanent Tag DB file.
      The ECA scripts will later extrapolate between the extreme locations to produce an approximation of the object called by us a “region of interest” that is identified with the object throughout its duration of visibility, and that is indexed by each frame's ‘z’ value and its Tag.
   (5) Any subsequent interaction with the Object by a viewer over an Internet return link, such as by pointing with a device or clicking a mouse will result in a search of the selected z frame for those coordinates, which will correspond with the region of interest, which was associated with the Tag; and the viewer will be redirected to the file containing the Tag, other keywords and additional information, graphics or multimedia, or a link to a URL, together with a script that directs what happens next (i.e., show the label in a text box on screen, show the label in a crawler at the bottom of the screen, connect to an advertiser's website, etc.)

### ETEP Method 2—Fully Automated Process

This process relies on an extension and expansion of the ECA into a fully-automated system of detection and tagging of all products, goods, services, merchandise, and businesses that appear in all the scenes of a film, TV or video program, as well as the automatic encoding of these object Tags into the video programs.

Using this approach a motion picture film, television or video program is run through the system's “smart” application designed to detect any products, goods, services, merchandize or businesses that appear in the scenes viewed. This process uses a unique Pattern Recognition Application (PRA) and is fully automated. As is done in the semi-automatic process, each time a product is identified by the PRA, a Tag is created and keywords corresponding to the identified item are automatically generated. In the same token the system will also record the exact coordinates of each item (in terms of location on the screen and time from origination and/or duration) and encode the Tag in the program, in the same manner as in Method ETEP-1.

At the end of each automated tagging and encoding process, an operator reviews all the Tags created by the system to ensure accuracy, and, when needed, they will add information to enhance the depth of information associated with a Tag (for example context of the scene, name of actor, name of character, etc.). The “smart” system is expected to increase its knowledge base and to decrease its error (failures to Tag) as the system is used time and again.

### 2) Encoding Process

A Note about Database-Driven Digital Video and how the EnContext System and Methodology Fits in

One of the current approaches for the encoding of the information on video programs that may be utilized is the broadcast video architecture of the Brazilian ISDTV-T standard (ABNT NBR 15606 Parts 1-5) that is used as an example below, where its middleware layer is deconstructed in detail to show how and where the system would interface with the signal structure. That does not diminish the applicability of the system to other main digital TV systems being developed (eg., ARIB B-24, DVB01, and ACAP05, as well as the Japanese ISDB standard). Nor does this initial conceptual environment rule out or diminish the application of the inventive system using other transport systems including satellite, cable TV, IPTV, and recorded media such as DVD and emerging formats such as the multimedia home platform (MHP03). The inventive system is also readily deployable under the architecture of the WiMax disaggregated broadcasting model, as well as WiFi within the “walled gardens” of major telecommunications networks developing mobile internet TV.

The system's ruling principles emerge from the relatively seamless internet experience perceived by many web page visitors as they are redirected to webpages hither and yon (on the internet) based on their selection of Ads, interests, their profile, site behavior, purchases or skips, etc.

### 2) The EnContext Merging Schema (EMS)

This process includes the various methods available via the system for connecting/merging Tags that identify embedded advertising opportunities or information labels to ad calls and links (referred in this document as “Offers”). These methods are outlined in the following scenarios, but may change in their details in actual operation:

EMS 1—In this instance the buying opportunities are all contained within the video itself on one of the available tracks. When the viewer initiates a request by pointing and clicking on an object on a screen (one thought to be of possible informational interest or for purchase) the ad call corresponding to the tag identifying the product within the program is made to one of the video tracks and the corresponding ad is displayed over or adjacent to the image. This solution is made available should no then available Internet connection be present or detected.

EMS 2—When viewer initiates a request by pointing and clicking on an object, the ad call corresponding to a Tag identifying the product within the program will display a message which is embedded within the video signal, but will also offer the option for the viewer to link to a website (either in real time when the program can be paused, or at the end of the program should the broadcast be a Live video transmission, all at the viewer's option).

EMS 3—In this method, when the viewer initiates a request by pointing and clicking on an object on the screen, the ad call corresponding to the Tag identifying the product within the program triggers a query to a local (or pre-loaded or virtual) data base to find the best possible match for that opportunity. It will then offer the option for the viewer to be linked to a website (either in real time when program can be paused, or at the end of the program if the broadcast is a Live transmission).

EMS 4—In this approach when the viewer initiates a request by pointing and clicking on an object on the video monitor or screen, the ad call corresponding to the Tag identifying the product within the program triggers a query to a dynamic and centralized data base. This query is sent via an Internet connection and is processed to find the best matches possible, selected on the basis of the product but also based on specific demographics, language, regions, etc. corresponding to the origin of the ad call and the viewer's demographic information. In this instance the viewer will then be presented with an ad or information that is tailored to him/her and will have the option to be linked to a website (either in real time when the program can be paused or at the end of the program when the broadcast is transmitted Live).

EMS 5—Using the Pattern Recognition Application (PRA) explained in the previous page (ETEP Method 2), the program contains no Tags but “scans” each scene to identify buying and information opportunities. When the viewer initiates a request by pointing and clicking on an object on the screen, the (PRA) identifies the object, and, in real time associates this item with keywords that will enable it to send a query to the data base (local or centralized), and find the best possible ad or information match. Once the match is found it is sent back to the viewing device, and the viewer will see the ad or information label and he/she then has the option to be linked to a website (either in real time) when the program can be paused or at the end of program when the broadcast is transmitted Live).

EMS 6—This approach complements scenarios 2, 3, 4 and 5 above. In this instance, when the program viewed has no “physical” Tags or Encoding present and PRA is not available then a query is sent to the central database to see if the program shown is known to the system. If “yes” then Tags and Encoding have been assigned and preserved in a central database, and a simple synchronization of the of Tags preserved in the “library” (central database) with the playing device (using time code or time, whichever is available) will enable the system to display Ads when the viewer clicks on an object within a scene. To ensure that the correct ad is shown when multiple ads are available for a scene, the inventive system keeps track of the exact location of the pointing device as it moves across the screen and transmits this information to the database. This information is then compared to the encoding records of the program and the corresponding ad is selected.

Example of Event Cascade from Viewer to Tag Schema

This example describes the possible steps that a typical ECA script would take. In this example, the steps relate to the real-time superposition of a label-style Tag on a screen object that a viewer has selected.
Return link from infrared pointer, laser pointer, bluetooth or other wireless link, via wireless Internet, IPTV, CATV return link, ‘second-screen solution’ via a separate computer connected to Internet, onboard ROM (DVD and recorded media), settop box (STB) using ECA software. etc.
   (1) Viewer uses a commonly-available or advanced-technology pointing device: could be mouse, infrared link inside a remote control, wireless mouse, etc. as above, or new technology, that supplies a signal via the return link to the program distributor that includes the “click” information (the time or “z” and the location or x-y coordinates where the pointer is aimed).
   (2) Start “z” counter
   (3) Error-checking methods commonly available will have been adapted to watch for additional viewer signals, and filter response via decision rules (imputes motives to viewer and deals with additional signals from the same approximate x-y-z; treats as fumbles, changed mind, emphasis through repetition, etc., or interprets as actual new intention).
   (4) Index DB on ‘z’, so query Tag Schema Files for z-ranges matching z AND for x-ranges and y-ranges matching the viewer-supplied x-y cursor-supplied values corresponding to the z's.
      Take all objects in the Tag database that correspond in z, x, and y and read any accompanying scripts (different instructions for a single object, multiple objects that need to be disaggregated according to business rules, multiple objects that need to be cross-referenced with additional objects following a cross-sell strategy).
   (5) Initiate Event Cascade** (refer to Display-Scenarios below)
   (6) Initiate Navigation Scripts
   (7) Return Tag Schema
   (8) Tag is visible on viewer's screen (or is stored for review by viewer after program as viewer desires)
   (9) Monitor viewer's return link

Event Cascade for ECA Controller Scripts

Script queries contractual database and reviews contract code to determine nature of the viewer output for that object (which display scenario to follow).

Script constructs output schema according to contractual code (for example, simple label scenario and duration, screen crawler scenario and duration, search of DB files for associated retailers, provide “optimized” list of retailers according to arbitrary criteria such as geo-location of viewer, provide links using a lead auction or “page-rank” scenario, link to an exclusive advertiser's web page, link to an informational wiki, etc.)

### ETEP-1 Example Controller Script

Signals From Tag Schema To DB Files
Event Cascade (Example) for Producing Simple Label Scenario

| | |
|---|---|
| STEP-1 | Read Block Label Schema |
| | Object Tag Elements (Array) = |
| | {z[ ], (x-min[ ], y-min[ ]), (x-min[ ], y-max[ ]), (x-max[ ], y- |
| | max[ ]), (x-max[ ], y-min[ ]), centroid[z,x,y], area( )} |
| STEP-2 | Control (Navigation) Scripts (Blob Array of XML Scripts) |
| | (Psuedo code showing how Controller App uses navigation scripts |
| | in Event Cascade for Simple Block Label scenario) |
| | Track STEP-1 by reading Object TE at ‘z’ |
| | ‘Get’ STEP-2 |
| | ‘Get’ STEP-3 |
| | ‘Get’ STEP-5 |
| | Call SUPERPOSE-1 |
| | ‘Get’ STEP-7 |
| | Read STEP-7 type code |
| | Read FLAG-1 AND SKIP |
| | Call SAVE-1 |
| | Call SUPERPOSE-2 |
| | REPEAT by ‘z’ |
| | END |
| STEP-3 | Names (Array) |
| STEP-4 | Informational (Blob Array) |
| STEP-5 | Graphics (Graphics Array) |
| STEP-6 | Multimedia (Blob Array) |
| STEP-7 | Contractuals (Blob Array) |
| SUPERPOSE-1 | ‘Put’ STEP-3 on STEP -5 |
| | END SUPERPOSE-1 |
| FLAG-1 | (Logical Bit) |
| SAVE-1 | Associate STEP -7 with STEP -1 |
| | ‘Set’ FLAG-1 |
| | END SAVE-1 |
| SUPERPOSE-2 | ‘Put’ SUPERPOSE-1 on STEP -1 by STEP -7 |
| | END SUPERPOSE-2 |
| REPEAT | Repeat While, etc. conditional procedure repeats series of steps while a |
| | condition is true |
| LOG EVENT | ‘Put’ SAVE-1 in TRANSACTIONS_LOG File and Assign ID-number and |
| | link to archive containing clickstream data, transaction history, and data elements |

```
Crawler Schema Scenario
    Event Cascade similar to example above
    Log Event stored as above
Search Engine (Optimized) Page-Rank Page Scenario
    Event Cascade similar to example above
    Log Event stored as above
Search Engine (Optimized) Page-Rank With One or More Icons/Links Per
        Advertiser -Scenario
    Event Cascade similar to example above
    Log Event stored as above
Single Advertiser's Page Scenario
    Internet Advertising Methods and Communications Protocols
    Log Event stored as above
Informational Wiki/Web Page Scenario
    Internet Communications Protocols
    Log Event stored as above
```

A menu of contractual arrangement ‘codes’ will be available to guide the Operator in constructing the scenarios depicted above. The most complex scenarios will entail strategies for disaggregating products appearing coincidentally (especially when all of those items are commercially-sponsored by separate Advertisers), and for cross-linking related elements of a larger marketing strategy that appear repeatedly or in related forms in multiple locations in the program.

An intelligent solution will enable the video viewer to setup the system in any way that is convenient for him/her.
For example the ability to set up the system in order to never interrupt the program but, rather, to record any clicks for later review.
Another setup would permit the user to be able to see the “Flag” corresponding to an object only when clicking occurs.
Yet again viewer could setup the system to view the information about an object as a caption like display when clicking on that object and yet allowing the content to continue, uninterrupted.

A number of other settings are possible and the programming should be as flexible as possible to accommodate the needs of the viewer.

### 4) Delivery Methodology

Another powerful capability of the invention is to make buying opportunities or information associated with items in or on a scene available to anyone, anywhere in the world, simultaneously. Indeed while people in NY, Paris or Tokyo may have the ability to see a simulcast at the exact same moment (the Olympics, for example), the links that will be offered to each would be highly customized to correspond to their geo-location (purchase of airline flights to the next Olympic venue from the location of the viewer). As a result, if we assume for example instead of the Olympics that people in these three cities are watching the same football/soccer game, and that a commemorative ball is being offered, the following scenario will ensue. Upon a click on the item the person in New York would be taken to Sports Authority.com in the US (and, for that matter, potentially to the brick and mortar store offering the ball in that person's own neighborhood) while the person in Paris will be directed to a local sporting goods store in his city, while the same scenario would play for the person in Tokyo but this time he or she will be directed to the website of a store in the Ginza district of that city or to a brick and mortar store offering the ball, there.

Description of the invention will now be given with reference to FIGS. 1-9. It should be understood that these figures are exemplary in nature and in no way serve to limit the scope of the invention, which is defined by the claims appearing hereinbelow.

The basic concept is shown in FIG. 1 with a viewer being able to see and interact with embedded ads within the images of a video program.

In the basic concept for the system, a viewer (50) watches an encoded video program (100) via a television or cable network or a video playback device enabling him/her to see things, hear things, consider services, i.e., buying or information opportunities (Ads) on a TV monitor or computer screen (49). Each Ad is associated with specific items such as “Buy this Helmet” for a helmet (121), “Buy this Football” for a football (122), “Buy these Shoes” for shoes (123), and “Buy Tickets for Game” for the overall image (124) as shown in this example. The Viewer uses a Pointing Device (48) such as a controller or computer mouse to point and click on one or more Ads on the monitor. The system has the capability of detecting the pointer and its location on the screen and the time of the pointing action (either by a specific time from the beginning of the program or another method of identifying the time of pointing) and thus the system identifies the selected opportunity and directs the viewer to the corresponding advertiser's website (101) using the viewer's Internet Browser or a similar interface. Once on this advertiser's website the viewer can make a purchase or gather information on the selected product. When he/she is finished with that action, the viewer returns to the program and continues viewing.

A more expanded overview of the inventive system is shown in FIG. 2, which shows how the system would work in unison with a data base that is queried using an Internet connection in order to query for a “best” possible match and deliver an Ad message or Link to an advertising domain that follows or obeys business rules for pricing, geo location, demographics, IP address or viewer or any additional information available.

As explained in FIG. 1, viewer (50) watches an encoded video program (100) via a television or cable network or a video playback device enabling him/her to see buying or information opportunities (Ads) on a TV monitor or computer screen (49). Each Ad is associated with specific items such as “Buy this Helmet” (121), “Buy this Football” (122), “Buy these Shoes” (123), and “Buy Tickets for Game” for the overall image (124) as shown in the example. Each instance of Ad is embedded directly into the video signal in the form of a Tag that contains information that is specific to defining this Ad including title, keyword, description and other relevant information. Viewer uses a Pointing Device (48) such as a controller or computer mouse to point and click on one or more Ads which action is detected by the monitor/screen or the system.

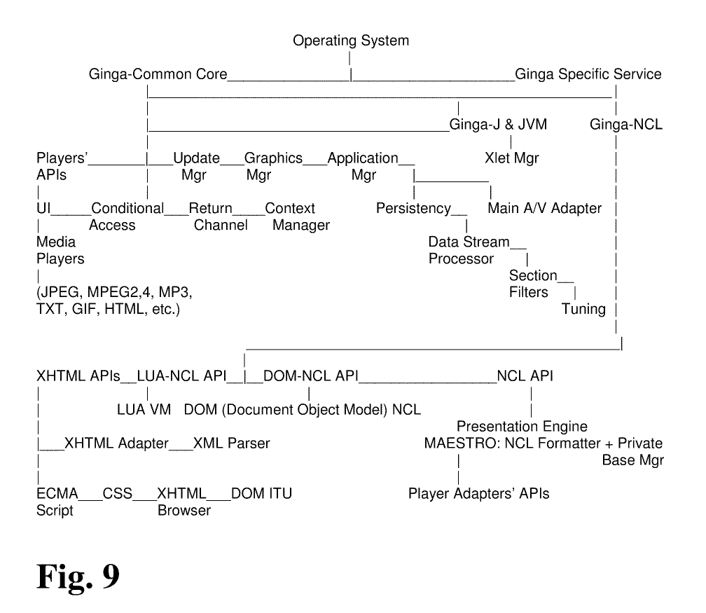

As shown on FIG. 2, when an Ad is selected (viewer points and clicks) the system identifies the Tag associated with the item selected on the screen (49), reads the information encoded on the Tag (including keyword, title, comments, etc.) as shown in FIG. 9 (to be described in more detail below), for example. The system then sends a query via an Internet connection (directly or via the viewer's computer (102)) to a data server (103) connected to a data base (104) that contains the offers matching each Tag. The request is processed, and the Tag information corresponding to the product is matched with a result as explained in the later described Figures. Based on business rules and other criteria the result of this query will be sent back to the viewer's computer or monitor for simultaneous viewing or later viewing.

To accomplish this, the Data Base (104) conducts a search of all its data fields for “best” possible match using optimization criteria to render this search very quickly, while applying any pre-set business rules and/or filters such as exclusive offer restriction, results based on highest bid, preferential display, geo-targeting, demographic targeting, etc.

The script that is then returned to the viewer with the result of the query will display the result on the screen in the form of a message (in any visual and audio format) or will open the viewer's Internet Browser and redirect him/her to the website selected by the data base. When this is done the viewer will review the advertiser's website and product page corresponding to the item selected on the screen. From there the viewer is able to make a purchase or gather information on the object he/she selected on the screen.

Depending on the program type that the viewer is watching, a number of pre-programmed options will be available to the viewer as follows:

1) During live broadcast, user will have the ability to record his/her product selection (by pointing and clicking on object) and save this selection for later review. This approach will enable users to select product while continuing to watch a program uninterrupted.

At the end of the program the system will allow user to review all products and services selected and click on any saved by the system to trigger the query “mechanism” as explained above.

2) During pre-recorded broadcasts via a playback machine or when a cable or TV broadcaster enables the viewer to stop and re-start the program viewed at will, the viewer will have the option to select a product and stop the viewing of the program while he/she accesses this product information via a link to the advertiser or additional information being displayed on the screen.

In this instance (2) the viewer will be able to restart the program at the exact same place where it was stopped.

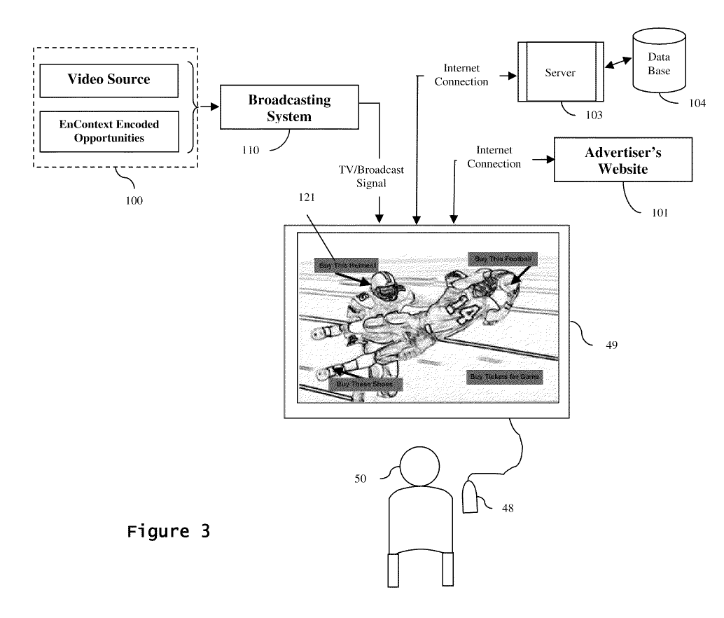

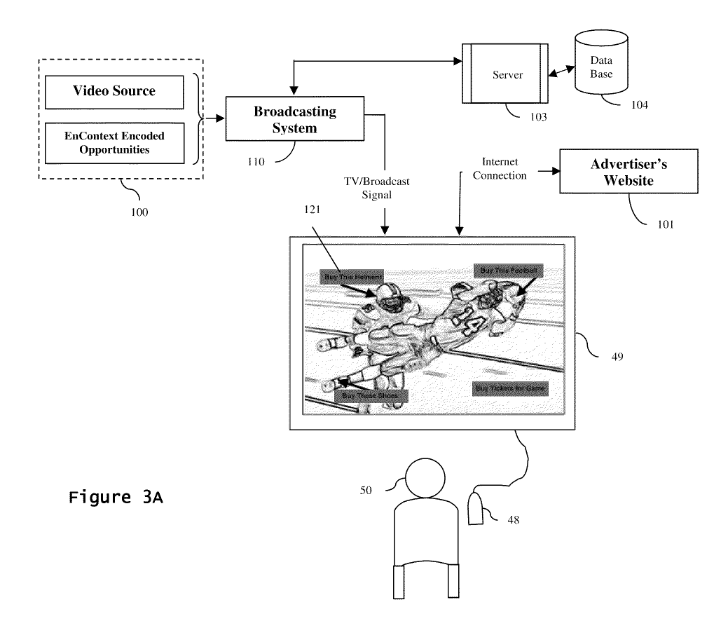

FIG. 3 describes how “Ads” may be delivered to a viewer monitor or screen as explained in FIGS. 1 and 2 using a remote server that is connected to the viewer's system via an Internet connection.

A viewer (50) watches an encoded program (100) provided by a Broadcaster via a broadcasting system (110) (broadcasting system may be terrestrial, cable TV, Satellite TV, closed circuit or any system that broadcasts moving images via a video analog or digital signal) that contains embedded information and/or buying opportunities (Ads) associated with specific items or services in the scenes of the broadcasted program as explained on FIGS. 1 and 2.

Viewer (50) points and clicks on an item (121) displayed on his/her monitor or screen (49) using a pointing device (48). A Tag associated with the item selected by the viewer (49) is decoded and a query is sent via an Internet connection to a remote data base (104) using a remote server (103) as explained in connection with FIG. 2. Results from the data base (104) such as informational messages or Links to advertisers' websites are returned via the server (101) to the viewer system via a direct Internet Connection.

The system enables viewers to review options offered by the returned information and/or links and take an action.

FIG. 3A describes how “Ads” may be delivered to a viewer monitor or screen as explained in FIGS. 1 and 2 using an integrated server that is connected to the broadcaster's system and uses the connection from the broadcaster to the viewer's home system to deliver Ads or Links.

A viewer (50) watches an encoded program (100) provided by a Broadcaster via a broadcasting system (110) (broadcasting system may be Terrestrial, cable television, Satellite TV, closed circuit or any system that broadcasts moving images via a video analog or digital signal) that contains embedded information and/or buying opportunities (Ads) associated with specific items or services suggested by or physically in the scenes of the broadcasted program as explained on FIGS. 1 and 2.

Viewer (50) points and clicks on an item (21) displayed on his/her monitor or screen (49) using a pointing device (48). The monitor or screen detects the location of the pointing and clicking. The Tag associated with the item selected by the viewer is decoded and a query is sent to a remote data base (104) using the remote server (103) as explained in FIG. 3.

However in this instance the query that is sent to the database uses the Broadcasting system (110) and return link from the viewer's system to the Broadcaster to communicate with the database (104). Results from the query of the database (104) such as informational messages or Links to advertisers' websites are then sent via server (101) to the viewer system using the broadcaster system (110) and link.

In this example, the database is queried from the viewer's system via the broadcaster's link and uses the connection from the broadcaster to the viewer to receive queries and return results.

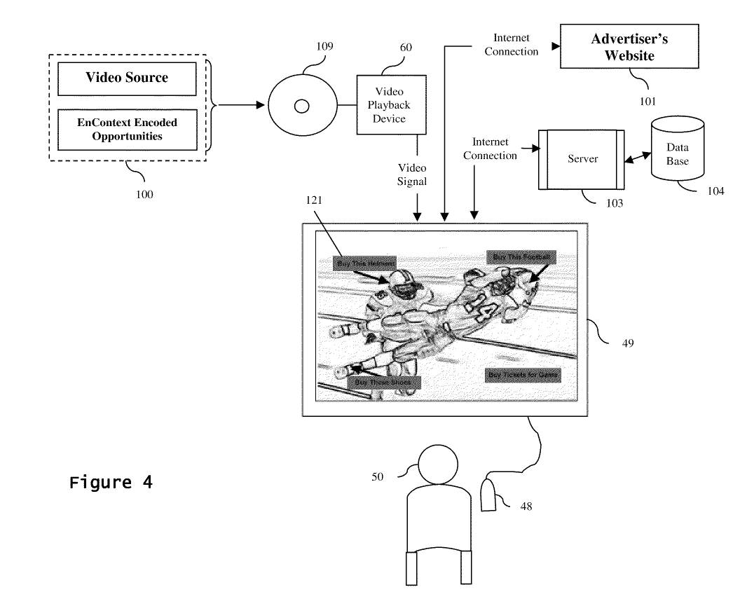

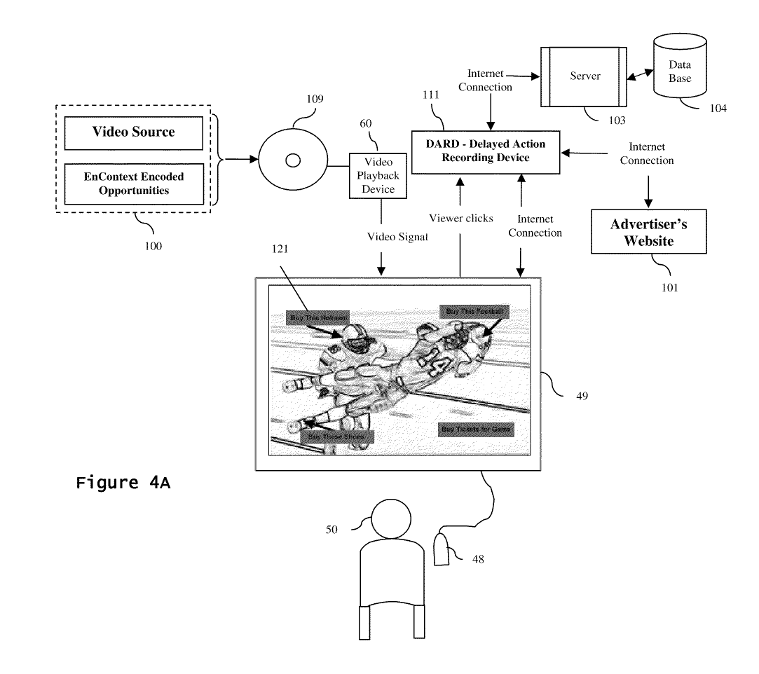

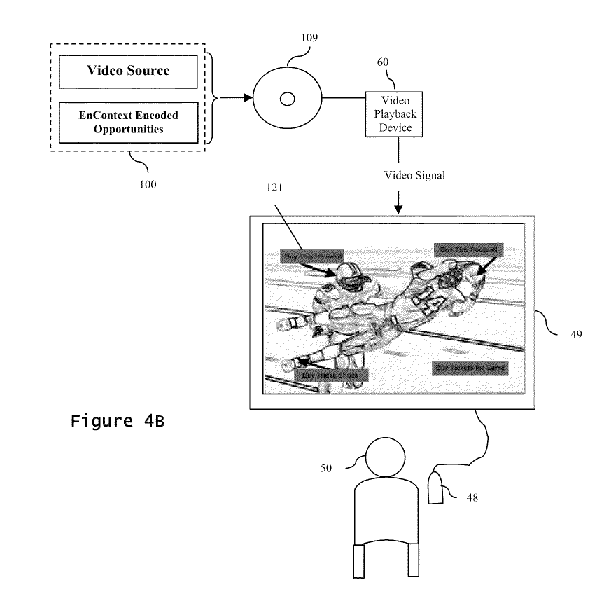

As shown in FIG. 4, Viewer watches an encoded pre-recorded video program (via DVD, CVD, Blue Ray, iPod Video or any video recording and playback device) that contains embedded “Ads” that are associated with specific items in the scenes of the program. The Viewer points and clicks on an item and is taken to the Advertiser's website or information page where he/she can buy or get information on that item.

As shown in previous Figures, opportunities have been encoded into and onto the video program. However in FIG. 4, the program containing these opportunities is recorded on a medium. Encoded programs (100) are recorded on a media (109) such as a DVD, Blue Ray DVD, VCD, or any similar media capable or reproducing images. These media are viewed using a video playback device (60) such as a DVD player, Blue Ray DVD Player, i-touch, or from memory chips on video playback devices or computers.

FIG. 4 shows an example of an encoded program (100) that is viewed on a monitor or screen (49) using available video playback device (60) and an electronic connection. The system using the device or the viewer's computer or other means of connection is connected to the Internet and able to communicate using basic Internet protocols.

When the viewer (50) uses his pointing device (48) to point and click on an item (121) that appears on the screen (49), the Tag associated with this item is decoded and a query is sent to a database (104) via a server (103). The communication between the viewer system and the database (104) is ensured via a direct Internet connection as previously explained in FIGS. 2 and 3. Returned results from the database (104) are then displayed on the viewer's monitor or screen (49) in the same manner as explained in previous FIGS. 2 and 3.

In FIG. 4A, the Viewer watches an encoded pre-recorded video program (via DVD, CVD, Blue Ray, iPod Video or any video recording and playback device) that contains embedded “Ads” that are associated with specific physical or suggested items or services by the scenes of the video program. Here, a video playback device is not connected to the Internet and when the viewer points and clicks on an item his/her action is recorded. When an Internet connection is later established, the viewer is given the option to review his/her click selection and is then able to select any item and connect with the Advertiser's website or information page where the viewer, i.e., he/she, can buy or get information on that item or service.

As in FIG. 4, the program containing advertising opportunities is recorded on a medium. Encoded programs* (100) are recorded on a media (109) such as a DVD, Blue Ray DVD, VCD, or any similar media capable of reproducing images. These media are viewed using a video playback device (60) such as a DVD player, Blue Ray DVD Player or from memory chips on video playback devices or computers. However, in FIG. 4A the viewer's system is not connected to the Internet or not able to connect to the Internet and has no other access to Internet communication.

When the viewer (50) uses his pointing device (48) to select and then click the item (121) that is displayed on the screen (49), the Tag associated with this item is decoded. Since an Internet connection is not available, the system is able to determine that a connection cannot be established, and, instead, records the viewer's action and stores it on DARD* (Delayed Action Recording Device) (111).

When an Internet connection is either re-established or separately and originally established, and the communication between the viewer's system and the data base is made, the DARD will communicate with the data base and sends queries as previously explained in FIGS. 2, 3 and 4. Returned results from the data base are then displayed on the viewer's monitor or screen (49) in the same manner as explained in previous Figures. However in this instance since more than one instance of Ads may have been selected, the viewer is provided with a list of his selection and can choose to review any or all of them and be linked to an information or advertiser's website.

In FIG. 4B, Viewer watches an encoded pre-recorded video program (via DVD, CVD, Blue Ray, iPod Video or any video recording and playback device) that contains embedded “Ads” that are associated with specific items in the scenes of the program. In this instance the video playback device will never be connected to the Internet i.e., it is incapable of connection.

Encoded programs (100) are recorded on a media (109) such as a DVD, Blue Ray DVD, VCD, or any similar media capable or reproducing images. These media are viewed using a video playback device (60) such as a DVD player, Blue Ray DVD Player or from memory chips on video playback devices or computers.

However, as shown in FIG. 4B, neither the device nor the viewer's system are connected to the Internet or designed for any Internet communication.

In this instance additional information on the Tag will provide for the information of the advertiser's message that will be displayed on the screen of the viewer. Encoded Ads will be self contained on one of the available tracks of the Media and display their content merely upon a click from the viewer (while watching, while stopping the video, or at the end of the session).

FIG. 5 depicts the approach that is implemented when an exclusive agreement between advertiser and broadcaster is in place. The system will query and send the viewer to a specific Internet web address or web page every time the viewer selects an item and clicks on the image on the screen.

When a viewer clicks on an Ad as shown in the previous FIGS. 1-4, the Tag that contains the product information and command is “read” and this information is included into the query to the database. The database then looks for the best possible matches for this Ad based on the information received. These matches are then run through the Business Rule Engine that applies business rules. When Business Rules are based on exclusive rules (for example a company has contracted for the exclusive right to supply an item or specific geo-targeting criteria for another item), then the only match (website) that fits this rule will be returned to the viewer.

FIG. 5A depicts the approach that is implemented when non-exclusive agreements are in place. When a product link is offered with no exclusivity agreement in place, various suppliers/advertisers are offered the option to bid for linkage to their website.

When a viewer clicks on an item on the screen, the Tag will de decoded and the query to the data base sent normally. However this time the data base will select from possible matches and based on business rules will return the match that best fits all the rules or multiple matches. It is possible to provide for a list of links containing various advertisers' website addresses listed based on the highest bidder from top to bottom. Viewer will then have the ability to select the one he/she wants to review and click on it to be directed to the advertiser's website.

Rules may include selection based on highest bid for this item, multiple geo locations, demographics and other information related to viewer or item.

FIG. 6 shows how viewers who are based in various locations across the world and who are viewing an encoded broadcast will be able to click on the same item on their screen and be given information or directed to an advertiser's website in their country or region.

Viewers at various locations around the world are able to view the same program, click on the same item and are given the opportunity to review information or be taken to an advertiser's website in their country and region.

In this example when a user clicks on an Ad on a program the query is sent to a data base as explained previously. However the information or advertiser's website domain will be selected by the data base based on each user's respective locations. Viewers' location will be identified by the system using the program origination (French Broadcaster, Korean Broadcaster, US Broadcaster, etc.) as well as their exact locality (address, zip code, phone area code, etc. that may be available to broadcaster), or, if need be, the user's IP address with an option for the viewer to set preferences.

As a result, domains for advertisers offering buying opportunities or information on products, services and items that appear on the broadcast will be completely localized.

Furthermore, viewers from anywhere in the world will have the ability to see a program at the exact same moment, and be offered Ads that will link them to local advertisers based on geo-location. For example, if we assume that people in the three cities in FIG. 6 are viewing the same football game and that a commemorative football is being offered (121), the following scenario will ensue. Upon a click on this football, the viewer in New York will be taken to an online sporting good store in the US while the person in Paris will be directed to a France-based sporting goods store while the Tokyo viewer will be directed to an online sporting good store located or able to ship goods in Japan. Different viewers may receive different secondary content information based not only on their physical location but on any number of other demographic variables, such as age, income, gender, affiliations, and the like.

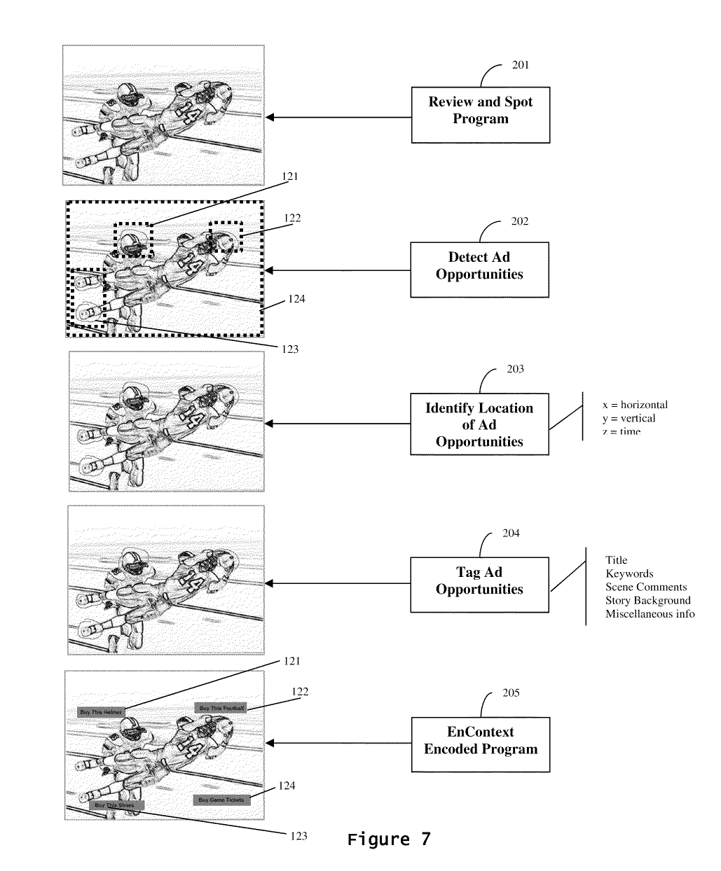

FIG. 7 illustrates how an operator would encode a program to associate objects identified as offering buying or information opportunities with their location within the program as well as Tag information that will define this object's “identity”.

As the first step of the encoding process (201), an operator reviews and “spots” objects of interest in a video program or movie using a simple time base for reference for the location of these objects, and data base for entries of identified buying opportunities (car, suit, hat, ball, shoes, helmet, vacation, etc.) as well as items of interest (historical sites, regions, cities, mountains, lakes, etc.).

During the second step of this process (202), the operator is able to select areas of a frame and scene that will need to be tracked and identified in space on the screen and monitor and time and for which Tags will be assigned. In this instance, as the example, a helmet (121), a football (122), sports shoes (123) as well as the football field (124) are considered to be of potential interest to a viewer (and by an advertiser seeking to sell goods and services).
To accomplish this the operator utilizes a simple pointing device that is able to “highlight” areas of a frame of various sizes as well as track these areas as they move within the scene or as the surrounding moves vis-à-vis the area selected.

In the third step (203), the operator is able to track these objects (as defined in step 2) as they move within a scene and enable the system to determine their x-y-z coordinates on the screen and within the program (with x=horizontal location; y=vertical location; z=time location) and record this information in a reference file (Master File) that will manage the overall system for a specific program by identifying the program (Program unique ID #), identifying each Ad (Ads ID#) and their location (Ad Location ID#), and associating these Ads and their locations with specific Tags (Tag ID#).
The system will be able to “understand” and manage the concept of overlapping objects within a scene and have the ability to “separate” overlapping yet “conflicting” objects or “tie” overlapping and complementary objects. These operations would be done using manual input from an Operator and machine assisted encoding to enable the various types of overlaps.
   An example of overlapping objects that need to be “separated” could be a car with a sign advertising for Pet Insurance and featuring a Golden Retriever on its doors. The available opportunities to buy an object or service or get information are all contained within the same area. They include the car (buy this car), the Pet Insurance (get a quote on Pet insurance) and the dog on the sign (learn about Golden Retrievers).
   An example of overlapping objects that need to be “joined” could be a scene featuring the Mickey Mouse on a Disney Cruise Ship, with the coastline of Jamaica in the background. In this instance an operator may decide to “tie” these items together to promote the Disney Caribbean Cruises.

In the step that follows (204), the operator creates Tags (Tags include name of object, type of object, keywords describing object, and additional descriptions as needed to enrich information on that object), and is able to define how and where these Tags will be used. For example Operator will instruct the system to link all Tags to a specific data base or area of the program when an Event is triggered
An Event is defined as the action taken by a viewer who points and clicks on an object on a screen. Assuming that the pointing and clicking device is somehow detected, either by the device and/or by the monitor or screen, this object contains a Tag, an Event initiates a specific action such as for example a call to a data base to search for matching information or buying opportunities. An Event can also initiate a call to an area of the program that contains information related to each object and may be limited to displaying a message.

In the final step (205) the system is then able to encode each object's Tag and the information that it contains into an area or available track of digital or analog video signal.

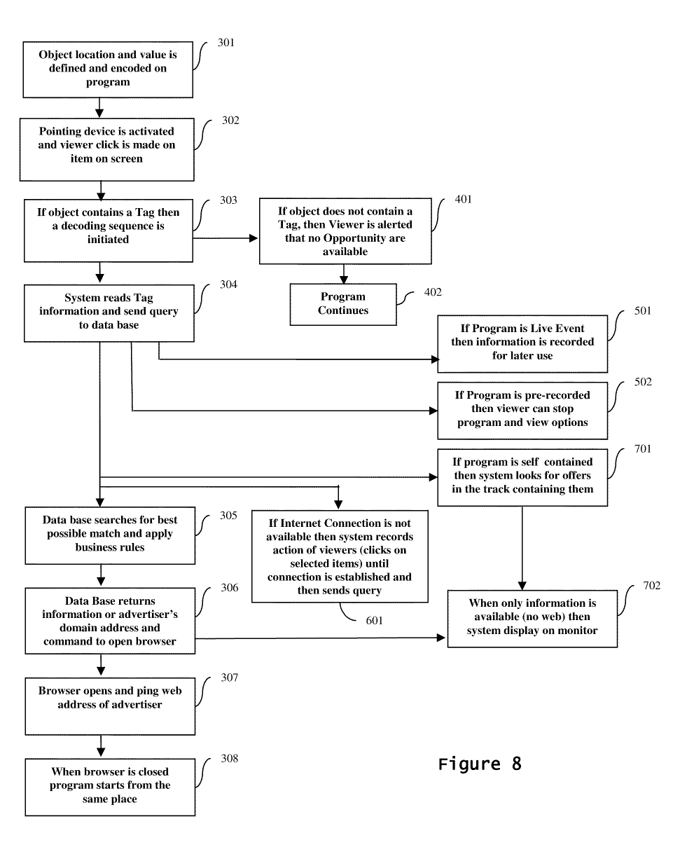

In operation, the invention works as depicted in FIG. 8 and as described as follows. FIG. 8 illustrates a typical sequence of events that takes place when a program contains encoded information or buying opportunities (Ads) (301).

A viewer uses a pointing devise to select an item on a screen and click to indicate his/her desire to buy or access information on that item (302).

If the object selected contains a Tag and related information on that item (303) then the content of that Tag is “read” by the system and a query is sent to a data base (304).

If the object selected does not contain a Tag and related information on that item (401) then the viewer is alerted that no opportunities are available for that item and the program continues playing (402).

If the program is a Live event that cannot be interrupted (501) then the query (304) is recorded but postponed until the program ends. The system will then prompt the viewer to review the selection and take action.

If the program is a recorded event that allows interruptions (freeze frames) (502) then the query (304) runs. The system prompts the viewer to review results and take action (save, or access advertiser's website) and if selected, access advertiser's website.

If the object selected contains a Tag and related information on that item but is in a self-contained media with no Internet connection (701) then the content of that Tag is “read” by the system and the query for information on that item is sent to the track where information is recorded (702).

If while query runs the Internet connection is not available or is interrupted (601) then system records the viewer's selection and posts an alert. System will continue to monitor Internet connection and prompt user with results and option when the connection is re-established.

When the query is received by the data base (305) it runs the query and selects the “best” matching offers and runs the Rules Engine to apply any rules for that item.

Once matches and application of rules are completed, the data base server sends back this information to viewer's system (306).

If an advertiser's website is an option, then system will open viewer's browser and “ping” advertiser's website domain (307).

If an offer that is sent back from query contains only information then this information is displayed on viewer's monitor with no further action (702).

When viewer has completed his purchase at advertiser's website or has finished reviewing information on informational website then he closes his browser and returns to watching the program that will start at the exact same place where it was stopped (308)

### Example of Tagging, Encoding, and Interactive Response by the System in Database-Driven TV

The Internet commerce paradigm inspires the database-driven video methodology. The schema used by the video controller software constructs the video frame from multiple sources, some of them analog, some of them database, and by introducing alternative pathways in response to the interactive signals from viewers (for example, by replacing metadata in the Ginga-NCL middleware, see below), within the XML-type files describing and constructing the video frame schemas, we gain a ready marriage between the video experience and the internet experience by virtue of the same database management techniques being used in both worlds and readily transacting when those worlds can combine.

One existing coding system that is preferred for use with the invention is Ginga-NCL, developed by Pontifical Catholic University of Rio de Janeiro, Brazil. All of the main systems developing digital TV use a “Presentation Engine” that uses an XHTML-based language. In the case of ISDTV, whose Middleware architecture, called “Ginga,” is mapped-out in hierarchical table form in FIG. 9, the language used is derived from XML and is called the Nested Context Language (NCL, now v.3.0). The high level overview of NCL shown in FIG. 9 demonstrates where and how the introduction of the inventive system would typically occur in a DTV program, as described herein.

The W3C-compliant structure module of NCL is page-based and contains a root element called <ncl> with two children elements, the <head> and the <body>.

The <head> element can have children elements <importedDocumentBase>, <ruleBase>, <transitionBase>, <regionBase>, <descriptorBase>, <connectorBase>, <meta>, and <metadata>.

The <body> element can have children elements <port>, <attribute>, <media>, <context>, <switch>, and <link>. The nested context model (NCM05) is the data model for NCL, and the <body> element is used as a “context node” in NCM (which can define a node as a context, a switch, or a media object). A context node can contain other NCM nodes and links, switch nodes contain other NCM nodes, and NCM nodes are represented by corresponding NCL elements. The present interpretation envisions the EnContext signal and data most probably acting within a context node located within a switch node.

The <media> element specifies a media object's type and the location of its content.

The <context> element defines context nodes, composite nodes containing sets of nodes and links. The <context> element can itself have as children <port>, <attribute>, <media>, <context>, <switch>, and <link>.

The <switch> element defines alternative document (a “document” is a page or frame of television) nodes (<media>, <context>, and <switch> elements) that may be chosen at presentation time. Rules for selecting the <switch> element are defined by <rule> or <compositeRule> grouped by <ruleBase> (a child of <head>). The inventive system would be activated as the result of a conditional applied to a rule.

The Interfaces allow node interface definitions used in relations with other node interfaces. The <area> element defines content anchors for spatial portions, time portions, or both for a media object (<media> element) content. The <port> element defines a composite node (<context>, <body> or <switch> element) port together with its mapping to an interface of one of its child elements. The <attribute> element defines a node attribute or group of node attributes as a node's interface, that is mapped to a set of alternative interfaces of the switch's internal nodes.

The <descriptor> element defines time and space information for presenting each document's components. It can provide a <region> element to define the initial position of the <media> element associated with the <descriptor> element as it is presented in an output device. Definition of <descriptor> elements occurs in the document <head> inside the <descriptorBase> element (that specifies the set of descriptors for the document). The <regionBase> element occurs inside the document <head> element and defines a set of <region> elements (each may contain another, recursively-nested set of <region> elements) that define device areas, such as screen windows, that are referenced by <descriptor> elements. It is in the <descriptor> element that the inventive links and scripts wait for the signal to activate.

A <causalConnector> element defines the relation that creates a <link> element in a document. A condition is satisfied and an action is triggered in a causal relation. A <link> element contains <bind> elements and connects a node interface with connector roles. That is how spatial and timing relationships among NCL objects (represented by <media>, <context>, <body> or <switch> elements) are defined.

The <descriptorSwitch> element defines a set of alternative descriptors to be used with an object, and works similarly to the <switch> element, but is referenced during document presentation and uses test rules defined by <rule> and <compositeRule> elements.

Already-defined entity bases are incorporated using the <importBase> element, and an NCL document can be imported using the <importNCL> element. The <importedDocumentBase> element defines a set of imported NCL documents and must be defined as a child of the <head> element. The inventive Tag and its accompanying procedures can be imported as an alternative element in the document and integrated (“multiplexed” in the analog world) with the presentation.

NCL documents are described using <meta> (specifies a single property/value pair) and <metadata> (acts as the root of an RDF tree; see W3C [RDF99] recommendations) elements.

Having described certain embodiments of the invention, it should be understood that the invention is not limited to the above description or the attached exemplary drawings. Rather, the scope of the invention is defined by the claims appearing hereinbelow and any equivalents thereof as would be appreciated by one of ordinary skill in the art.

What is claimed is:

1. A method of associating primary content in a broadcast video program with secondary content information not shown in the program, comprising the steps of:
a) providing a broadcastable video program of primary content on a machine-readable medium, the program having successive image frames and each frame having a plurality of coordinates;
b) embedding codes in at least some of the frames, each code corresponding to an area of coordinates of the image frames;
c) linking each code via links to information of secondary content not appearing in the image frames of the program, at least one of the links or the linked-to information being stored on a computer-readable medium; and
d) providing an interactable interface to program viewers of the primary content adapted to allow the viewers to activate the embedded links and retrieve the secondary content of the linked-to information.

2. A method according to claim 1, wherein the coordinates include pixels in an X-Y array.

3. A method according to claim 2, wherein the area of coordinates corresponds to an object shown in the image frames.

4. A method according to claim 3, wherein each coded object has X-Y spatial frame coordinates and Z-frame info identifying the object in space and time in the program.

5. A method according to claim 1, further comprising the step of e) providing the video program primary content on a first machine-readable medium and the linked-to information secondary content on a second machine-readable medium.

6. A method according to claim 5, wherein said step e) further comprises the steps of:
providing the broadcast video program primary content on a broadcaster's server; and
providing the linked-to information secondary content on an advertiser's server.

7. A method according to claim 6, wherein the linked-to secondary content information pertains to the primary content object tagged by the code.

8. A method according to claim 7, wherein said step d) further comprises the steps of enabling the viewer to purchase an instance of the tagged object selected by the viewer.

9. A method according to claim 1, further comprising the steps of overlaying the selected linked-to secondary content atop the primary content corresponding to the embedded code.

10. A method according to claim 4, comprising the steps of overlaying the selected linked-to secondary content atop the primary content corresponding to the coded object.

11. A method according to claim 1, said step c) further comprising the step of presenting different links to secondary content to different viewers based on viewer demographic variables.

12. A method according to claim 1, said step b) further comprising the step of embedding different codes corresponding to different areas of the image frames for different viewers based on viewer demographic variables.

13. A method according to claim 1, said embedding step b) further comprising the step of embedding the code directly into the video signal of the broadcast program.

14. A method according to claim 1, said embedding step b) further comprising the steps of:
1) scanning the primary content video program;
2) detecting objects shown in the image frames; and
3) automatically embedding codes corresponding to the detected objects.

15. A method according to claim 14, further comprising the step of providing a pattern recognition program, wherein steps 1) and 2) are performed by the pattern recognition program.

16. A method according to claim 14, wherein steps 1) and 2) are performed by a human operator.

17. A method according to claim 3, further comprising the step of providing a database containing multiple versions of secondary content corresponding to each coded object.

18. A method according to claim 17, further comprising the step of, when a viewer activates an embedded link, querying the database and determining which version of the corresponding secondary content is most optimally sent to a given viewer.

19. A method according to claim 18, said querying and determining step basing the determination on viewer demographic variables.

20. A method according to claim 17, further comprising the steps of:
providing to the viewer multiple versions of secondary content corresponding to the selected coded object; and
enabling the viewer to select which version of the secondary content is most appropriate.
